(19) United States
(12) Patent Application Publication
(10) Pub. No.: US 2010/0050808 A1
(43) Pub. Date: Mar. 4, 2010

(54) Rim of Steering Wheel for Vehicle

(75) Inventors: Junyong MIN, Gyunggi-Do (KR); Byungwoo NO, Gyunggi-Do (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/548,099

(22) Filed: Aug. 26, 2009

(30) Foreign Application Priority Data
Sep. 2, 2008 (KR) 10-2008-0086131

(51) Int. Cl. B62D 1/06

(52) U.S. Cl. 74/552

(57) ABSTRACT

A rim of a steering wheel for a vehicle may include polyurethane foam coupled onto an entire surface of an amateur constituting a frame of the rim, a hot wire pad adhering to an entire outer surface of the polyurethane foam, and a real wood and a leather cover respectively attached to an outer surface of the hot wire pad to be connected to each other, wherein a clip member is disposed between the hot wire pad and a connection portion of the real wood and the leather cover, and the connection portion is attached to an outer surface of the clip member and an inner surface of the clip member is attached to the hot wire pad.

### CROSS-REFERENCE TO RELATED APPLICATIONS

The present application claims priority to Korean Application Serial Number 10-2008-0086131, filed on Sep. 2, 2008, the entire contents of which are incorporated herein for all purposes by this reference.

### BACKGROUND OF THE INVENTION

1. Field of the Invention

The present invention relates to a rim of a steering wheel for a vehicle that is capable of preventing a short circuit of a hot wire pad in a connection portion between real wood and a leather cover.

2. Description of Related Art

Generally, a steering wheel which a driver operates to change a moving direction of a vehicle includes an outline peripheral rim, a central hub, and a plurality of spokes 30 for connecting hub with rim.

A driver airbag module and a hone operation device are mounted on hub. The driver airbag module is covered by an airbag cover coupled with hub not to be exposed to the outside.

Meanwhile, in order to meet consumer's various requirements with upgrading of the vehicle, rim products manufactured by mixing real wood with a leather cover have been recently used. Further, products equipped with a hot wire pad therein have been used in order to remove a cool touch of rim in a winter season.

The hot wire pad is positioned in real wood and leather cover. Real wood and leather cover are attached so that ends of real wood and leather cover are connected to each other while covering the hot wire pad.

An adhesive such as a bond is applied onto inner surfaces of real wood and leather cover, and real wood and leather cover are attached to a surface of the hot wire pad by pressing force of a jig. A connection portion of real wood and leather cover is disallowed to include a portion caught by a driver's hand. Real wood and leather cover are attached to the surface of the hot wire pad in a state where the end of each of real wood and leather cover is rolled inside for aesthetic improvement.

At this time, real wood has a sharp end, thus, when the end is pressed by the jig with the end rolled inside, the hot wire pad is short-circuited. Therefore, the hot wire pad functions inadequately.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a rim of a steering wheel for a vehicle, which is capable of preventing an unnecessary short circuit of a hot wire pad at the time of attaching real wood and a leather cover by attaching a hot wire protecting clip member to a connection portion between the real wood and the leather cover and attaching ends of the real wood and the leather cover to be connected to each other on a surface of the clip member.

In an aspect of the present invention, the rim of a steering wheel for a vehicle, may include polyurethane foam coupled onto an entire surface of an amateur constituting a frame of the rim; a hot wire pad adhering to an entire outer surface of the polyurethane foam; and a real wood and a leather cover respectively attached to an outer surface of the hot wire pad to be connected to each other, wherein a clip member is disposed between the hot wire pad and a connection portion of the real wood and the leather cover, and the connection portion is attached to an outer surface of the clip member, and an inner surface of the clip member is attached to the outer surface of the hot wire pad.

The clip member may be composed of plural numbers to have a round ring shape at the time of being attached to the hot wire pad.

A clip groove for determining an attachment position of the clip member to the polyurethane foam may be integrally and concavely formed in the polyurethane foam and receives the clip member therein, wherein distal ends of the real wood and the leather cover is rolled inside to be attached to each other and to the outer surface of the clip member.

Distal ends of the real wood and the leather cover may be rolled inside to be attached to each other and to the outer surface of the clip member.

In order to achieve the above-described object of the present invention, a rim of a steering wheel for a vehicle according to an embodiment of the present invention includes: polyurethane foam coupled onto an entire surface of an amateur constituting a frame of the rim; a hot wire pad adhering to an entire surface of the polyurethane foam; and real wood and a leather cover respectively attached to a surface of the hot wire pad to be connected to each other, wherein a clip member is attached to a connection portion between the real wood and the leather cover in the hot wire pad, and ends of the real wood and the leather cover are attached to be connected to each other on a surface of the clip member.

According to the present invention, it is possible to prevent an unnecessary short circuit of a hot wire pad at the time of attaching real wood and a leather cover by attaching ends of the real wood and the leather cover to be connected to each other on a surface of the clip member, such that the hot wire pad functions adequately.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of a steering wheel with an exemplary rim according to the present invention.

FIG. 2 is a diagram for illustrating a process of manufacturing an exemplary rim for each step according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

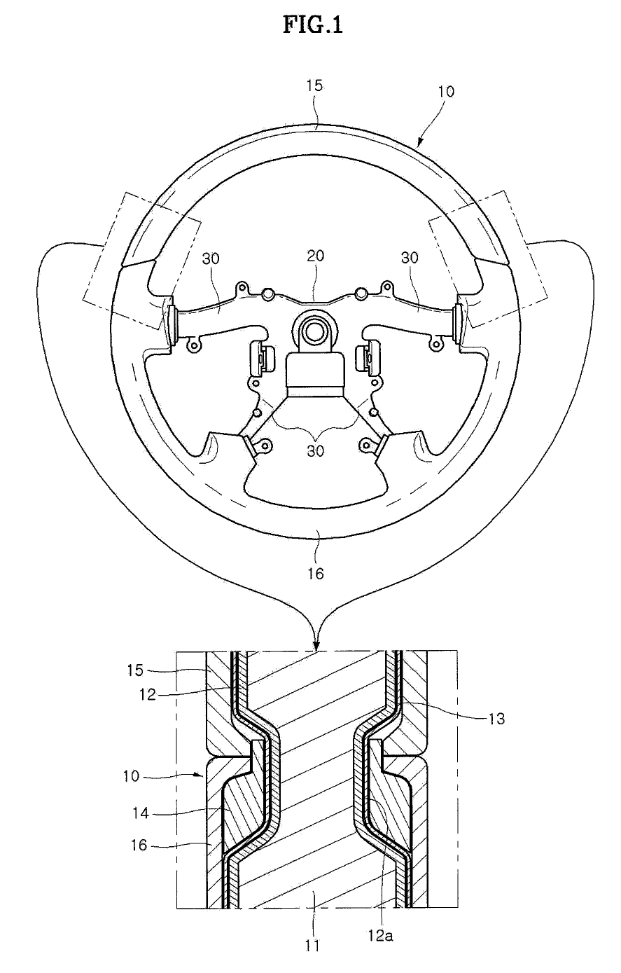

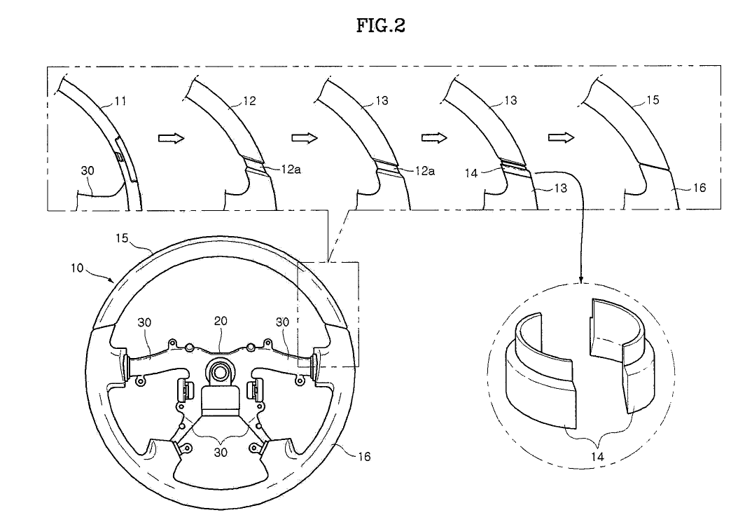

FIG. 1 is a perspective view of a steering wheel with an exemplary rim according to the present invention and FIG. 2 is a diagram for illustrating a process of manufacturing an exemplary rim for each step according to the present invention.

As shown in the figures, a steering wheel for a vehicle includes an outline peripheral rim 10, a central hub 20, and a plurality of spokes 30 for connecting hub 20 and rim 10.

A driver airbag module and a hone operation device are mounted on hub 20. The driver airbag module is covered by an airbag cover coupled with hub 20 not to be exposed to the outside.

Herein, rim 10 includes an amateur 11 made of magnesium, which serves as a frame while connecting hub 20, polyurethane foam 12 having a hard property, which is entirely coupled onto a surface of amateur 11, and a hot wire pad 13 adhering to an entire surface of polyurethane foam 12.

Hot wire pad 13 adheres to the entire surface of polyurethane foam 12 by means of a double coated adhesive tape.

Clip groove 12a is integrally formed in polyurethane foam 12. Clip groove 12a maintains its own shape as it is even after hot wire pad 13 adheres to the surface of polyurethane foam 12.

A clip member 14, which is made of plastic or steel, for preventing the short circuit of hot wire pad 13 is attached to clip groove 12a to which hot wire pad 13 is attached by means of a bond or the double coated adhesive tape.

Clip member 14 is composed of plural numbers to have a round ring shape at the time of being attached to clip groove 12a to which hot wire pad 13 adheres.

After clip member 14 is attached, real wood 15 and a leather cover 16 are attached to the surface of hot wire pad 13 to be connected to each other.

That is, an adhesive such as the bond is applied onto inner surfaces of real wood 15 and leather cover 16, and real wood 15 and leather cover 16 are pressed by using a jig, such that real wood 15 and leather cover 16 are attached to the surface of hot wire pad 13 to be connected to each other.

Meanwhile, a connection portion between real wood 15 and leather cover 16 is disallowed to include a portion caught by a driver's hand. Real wood 15 and leather cover 16 are attached to the surface of hot wire pad 13 in a state where the end of each of real wood 15 and leather cover 16 is rolled to the inside where hot wire pad is provided for aesthetic improvement.

At this time, real wood 15 has a sharp end, thus, when the end is pressed by the jig with the end rolled inside, hot wire pad 13 may be short-circuited by the end of real wood 15. Therefore, the hot wire pad functions inadequately. In order to prevent the problem, in the present invention, the connection between real wood 15 and leather cover 16 is attached to be connected on a surface of clip member 14.

As described above, when the connection portion between real wood 15 and leather cover 16 is attached to be connected on the surface of clip member 14, a possibility that hot wire pad 13 will be short-circuited by the end of real wood 15 is removed, thus, hot wire pad functions adequately.

For convenience in explanation and accurate definition in the appended claims, the terms “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A rim of a steering wheel for a vehicle, comprising:
polyurethane foam coupled onto an entire surface of an amateur constituting a frame of the rim;
a hot wire pad adhering to an entire outer surface of the polyurethane foam; and
a real wood and a leather cover respectively attached to an outer surface of the hot wire pad to be connected to each other,
wherein a clip member is disposed between the hot wire pad and a connection portion of the real wood and the leather cover, and the connection portion is attached to an outer surface of the clip member, and an inner surface of the clip member is attached to the outer surface of the hot wire pad.

2. The rim as defined in claim 1, wherein the clip member is composed of plural numbers to have a round ring shape at the time of being attached to the hot wire pad.

3. The rim as defined in claim 1, wherein a clip groove for determining an attachment position of the clip member to the polyurethane foam is integrally and concavely formed in the polyurethane foam and receives the clip member therein.

4. The rim as defined in claim 3, wherein distal ends of the real wood and the leather cover are rolled inside to be attached to each other and to the outer surface of the clip member.

5. The rim as defined in claim 1, wherein distal ends of the real wood and the leather cover are rolled inside to be attached to each other and to the outer surface of the clip member.
